(19) United States
(12) Patent Application Publication
(10) Pub. No.: US 2006/0013382 A1
(43) Pub. Date: Jan. 19, 2006

(54) Telephone exchange system and control method used for the same system

(76) Inventor: Takaaki Hoshikawa, Kawasaki-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/891,518

(22) Filed: Jul. 15, 2004

(51) Int. Cl. H04M 1/00; H04M 9/00

(52) U.S. Cl. 379/388.01; 379/387.01

(57) ABSTRACT

A telephone exchange apparatus includes a memory which stores several different volume values for each call mode indicating a combination of connected lines, a determination circuit configured to determine a call mode of the telephone terminal when a call is made using the telephone terminal in the on-hook state and a controller which controls the memory to read a volume value corresponding to the determined call mode from the memory, and sets the volume value to the calling telephone terminal.

### BACKGROUND OF THE INVENTION

1. Field of the Invention

The present invention relates to a telephone exchange apparatus, which includes several extensions each adapted to connect a telephone terminal, and adapted to connect with at least one outside line, adapted to make a call other telephone terminal in an on-hook sate by the telephone terminal. The present invention relates to a control method used for the telephone exchange apparatus.

2. Description of the Related Art

Conventionally, telephone exchange apparatus such as PBX (Private Branch Exchange) and button (key) telephone system have been frequently used in office buildings or business office. This kind of telephone exchange apparatus has a built-in telephone as an extension terminal. The telephone exchange apparatus enables a call in a manner of making an exchange and connected between the extension terminal and external telecommunication network such as public network and between the extension terminals.

On the other hand, a latest telephone exchange apparatus has a high function; therefore, it is connectable with a multi-functional telephone having a speakerphone function. The speakerphone function is a function of talking with a calling person making a call without holding a telephone receiver.

However, the speakerphone function has the following problem. During an extension call, the volume on the telephone of the receiver side becomes too large, in the used place. For this reason, a changeover from the speakerphone function to the transmission function is not made.

### BRIEF SUMMARY OF THE INVENTION

It is, therefore, an object of the present invention to provide a telephone exchange apparatus, which can effectively makes a speakerphone call in various call modes and various used place, and a control method used in the telephone exchange apparatus.

According to an aspect of the present invention, there is provided A telephone exchange apparatus, which includes several extensions each adapted to connect a telephone terminal, and adapted to connect with at least one outside line, adapted to make a call other telephone terminal in an on-hook sate by the telephone terminal, comprising: a memory which stores several different volume values for each call mode indicating a combination of connected lines; a determination circuit configured to determine a call mode of the telephone terminal when a call is made using the telephone terminal in the on-hook state; and a controller which controls the memory to read a volume value corresponding to the determined call mode from the memory, and sets the volume value to the calling telephone terminal.

According to another aspect of the present invention, there is provided a control method used for a telephone exchange apparatus, which includes several extensions each adapted to connect a telephone terminal, and adapted to connect with at least one outside line, adapted to make a call other telephone terminal in an on-hook sate by the telephone terminal, comprising: storing several different volume values for each call mode showing a combination of connected lines; determining a call mode of the telephone terminal when a call is made using the telephone terminal in the on-hook state; and reading a volume value corresponding to the determined call mode from the memory, and setting the volume value to the calling telephone terminal.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the embodiments given below, serve to explain the principles of the invention.

FIG. 1 is a block diagram showing the configuration of an exchange system according to a first embodiment of the present invention;

FIG. 2 is a view to explain memory contents of a volume value memory shown in FIG. 1;

FIG. 3 is a flowchart to explain the procedure of a main unit in the first embodiment;

FIG. 4 is a block diagram showing the configuration of an exchange system according to a second embodiment of the present invention;

FIG. 5 is a view to explain memory contents of a volume range memory shown in FIG. 4; and

FIG. 6 is a flowchart to explain the procedure of a main unit in the second embodiment.

### DETAILED DESCRIPTION OF THE INVENTION

Embodiments of the present invention will be described below with reference to the accompanying drawings.

### First Embodiment

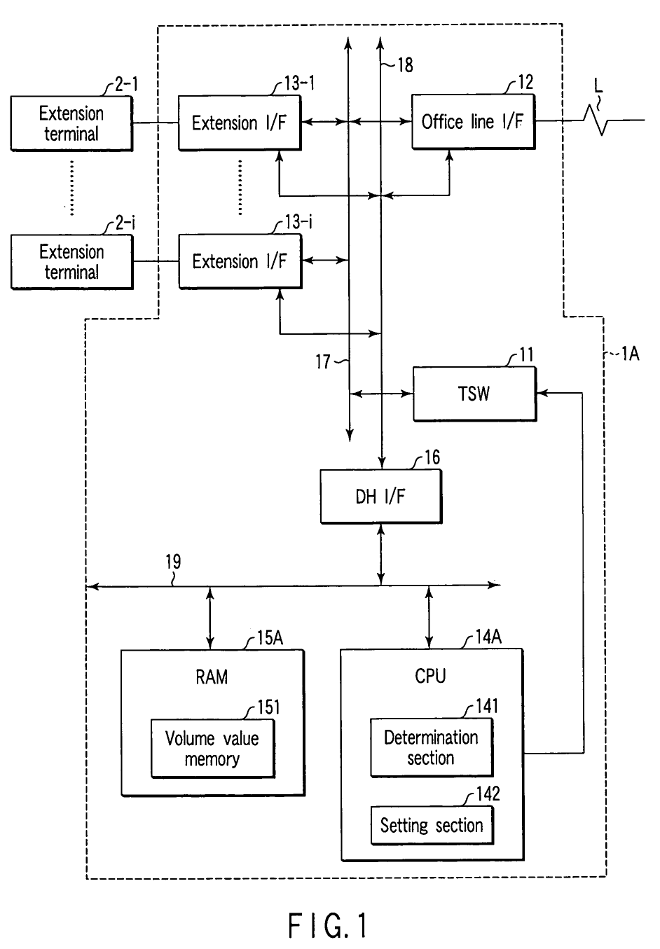

FIG. 1 is a block diagram showing the configuration of an exchange system according to a first embodiment of the present invention.

As shown in FIG. 1, the exchange system is formed in a manner that a main unit 1A is arbitrarily connected with several (maximum i) extension terminals 2 (2-1 to 2-i). A multi-functional telephone with speakerphone function is used as the extension terminal 2.

The main unit 1A includes time switch 11 (hereinafter referred to as TSW 11), office line interface circuit 12 (office line I/F 12) and several (i) extension interface circuits 13 (13-1 to 13-i)(extension I/F 13). The main unit 1A further includes control section 14A (CPU 14A), memory section 15A (RAM 15A) and data highway interface section 16 (DH I/F 16). The foregoing TSW 11, office line I/F 12 and extension I/F 13 are mutually connected via PCM highway 17.

The foregoing office line I/F 12, extension I/F 13 and DH I/F 16 are mutually connected via data highway 18. The foregoing CPU 14A, RAM 15A and DH I/F 16 are mutually connected via CPU bus 19. Incidentally, the TSW 11 is directly connected to the CPU 14A.

The TSW 11 makes replacement of time slot on the PCM highway 17 based on the control of the CPU 14A, and thereby, arbitrarily makes an exchange and connection between office line I/F 12 and extension I/F 13.

The office line I/F 12 is connected with an office line L as the need arises. Thus, the office line I/F 12 makes an interface operation relevant to the connected office line L. In addition, the office line I/F 12 makes an exchange with the CPU 14A with respect to various control information relevant to the interface operation via data highway 18, DH I/F 16 and CPU bus 19.

The extension I/F 13 is connected with an extension terminal 2 as the need arises. The extension I/F 13 makes an extension interface operation relevant to the connected extension terminal 2. The extension interface operation is as follows. A PCM signal outputted from the extension terminal 2 is extracted from the PCM highway 17, and the state of the extension terminal 2 is monitored. Further, various signals with respect to the extension terminal 2 are transmitted. The extension I/F 13 makes an exchange with the CPU 14A with respect to various control information relevant to the extension interface operation via data highway 18, DH I/F 16 and CPU bus 19.

The CPU 14A carries out processings based on operation programs stored in the RAM 15A to collectively control TSW 11, office line I/F 12 and extension I/F 13. By doing so, the CPU 14A realize the operation as the main unit 1A.

The RAM 15A stores the operation programs of the CPU 14A and other various data permanently used.

The DH I/F 16 makes a data exchange between data highway 18 and CPU bus 19.

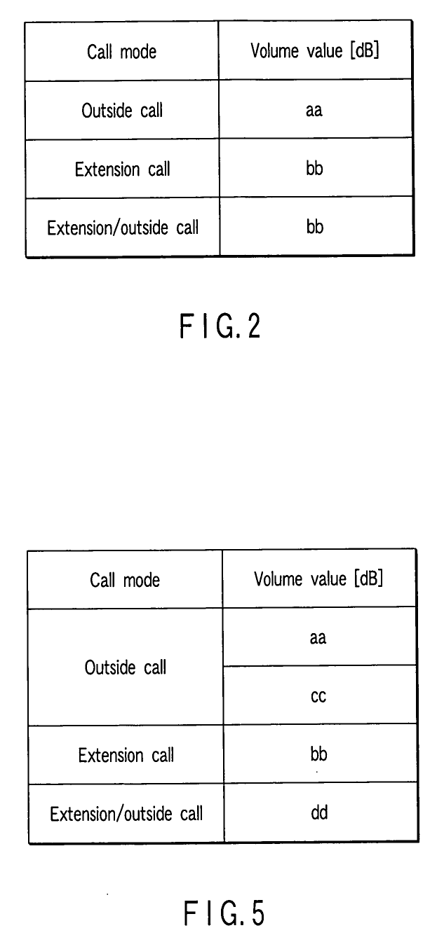

According to the first embodiment, the CPU 14A includes a determination section 141 and a setting section 142. The RAM 15A includes a volume value memory 151 (hereinafter referred to as volume memory 151). The volume memory 151 stores data showing the corresponding relationship between call modes and volume values, as shown in FIG. 2. One of the call modes is a speakerphone call between extension and outside line. Another is a speakerphone call between extensions. Another is a speakerphone call between extension and extension/outside line. Incidentally, the volume value “bb” is set smaller than the volume value “aa”.

When a speakerphone call is made through the extension terminal 2, the determination section 141 acquires call mode information from the extension terminal 2. Then, the determination section 141 determines a call mode from the acquired call mode information.

The setting section 142 reads a volume value corresponding to the call mode determined by the determination section 141 from the volume memory 151. Then, the setting section 142 transmits the volume value data to the extension terminal using the speakerphone call, and thereafter, sets it.

The operation of making the speakerphone call will be explained below.

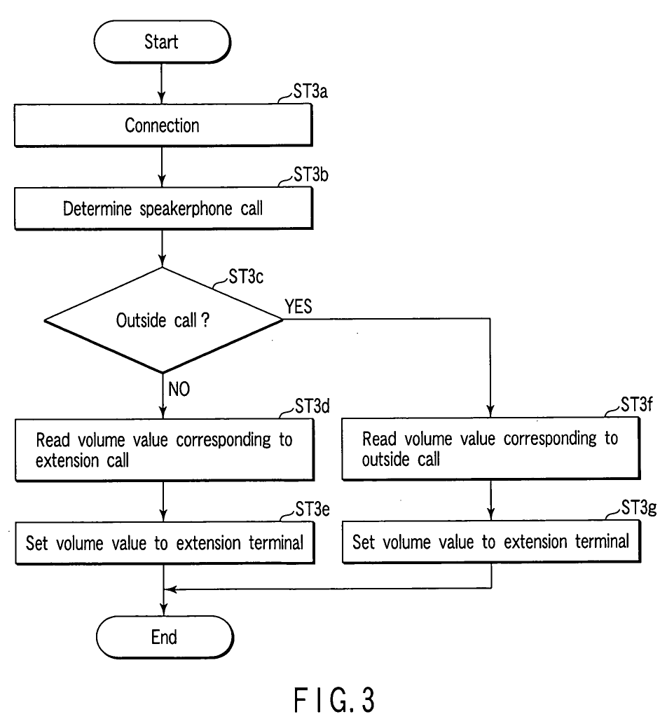

FIG. 3 is a flowchart to explain the procedure of the CPU 14A of the main unit 1A when making the speakerphone call.

For example, a user of an extension terminal 2-1 makes a call operation to an extension terminal 2-5 using on-hook dial, and inputs a dial number of the extension terminal 2-5. The CPU 14A of the main unit 1A recognizes that the dial number is depressed, and then, calls the extension terminal 2-5 (step ST3a).

When the user of the extension terminal 2-5 makes a response, the CPU 14A requires call mode information from the extension terminals 2-1 and 2-5, and makes a speakerphone call determination based on the call mode information (step ST3b). Thereafter, the CPU 14A makes a call mode determination (step ST3c).

In this case, the call mode is a call between extensions; therefore, the CPU 14A reads the volume value “bb” corresponding to the call between extensions from the volume memory 151 (step ST3d). Thereafter, the CPU 14A sets the volume value “bb” to the extension terminals 2-1 and 2-5 (step ST3e).

On the other hand, when the user of the extension terminal 2-1 makes a speakerphone call with an external terminal on the office line L, the CPU 14A reads the volume value “aa” corresponding to the outside call from the volume memory 151 (step ST3f). Thereafter, the CPU 14A sets the volume value “aa” to the extension terminal 2-1 (step ST3g).

In addition, a call is made between three persons using the speakerphone. That is, when the user of the extension terminal 2-1 makes a call between the external terminal on the office line L and the extension terminal 2-5, the CPU 14A reads the volume value “bb” corresponding to a call between extensions from the volume memory 151 (step ST3d). Thereafter, the CPU 14A sets the volume value “bb” to the extension terminal 2-1 (step ST3e).

According to the first embodiment, the data showing the corresponding relationship between call modes and volume values are stored in the volume value memory 151. When the extension terminal 2-1 makes the speakerphone call, the CPU 14A makes call mode determination. Based on the determination result, the CPU 14A reads the corresponding volume value from the volume memory 151, and set it to the extension terminal 2-1 using the speakerphone.

Therefore, the optimum volume value corresponding to the call mode is set to the extension terminal 2-1 using the speakerphone without requiring user's manual operation. By doing so, it is possible to prevent excessive setting of the volume on a call, and to solve the problem that a changeover from the speakerphone function to the transmission function is not made.

### Second Embodiment

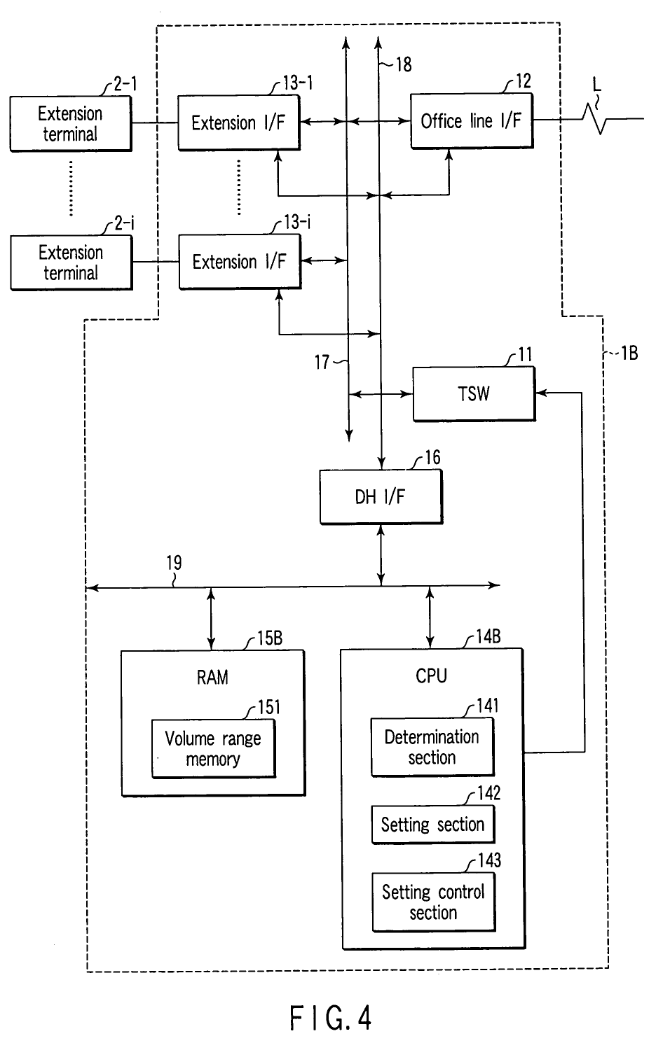

FIG. 4 is a block diagram showing the configuration of an exchange system according to a second embodiment of the present invention. In FIG. 4, the same reference numerals are used to designate parts identical to FIG. 1, and the details are omitted.

More specifically, a CPU 14B of a main unit 1B is provided with a setting control section 143 (hereinafter referred to as control section 143). A RAM 15B is provided with a volume range memory 152(hereinafter referred to as range memory 152).

The range memory 152 stores the following call modes and data showing the corresponding relationship between maximum and minimum volume values, as shown in FIG. 5. One of the call modes is a speakerphone call between extension and outside line. Another is a speakerphone call between extensions. Another is a speakerphone call between extension and extension/outside line. Incidentally, the volume value “bb” is set smaller than the volume value “aa”.

When volume adjustment is made in the extension terminal 2-1 making a speakerphone call, the control section 143 determines whether or not the adjusted volume value is more than the corresponding maximum volume value of the range memory 152. Only when the adjusted volume value is less than the maximum volume value, the control section 143 sets the adjusted volume value to the extension terminal 2-1. In addition, the control section 143 determines whether or not the adjusted volume value is more than the corresponding minimum volume value of the range memory 152. Only when the adjusted volume value is more than the minimum volume value, the control section 143 sets the adjusted volume value to the extension terminal 2-1.

The operation of making the speakerphone call will be explained below.

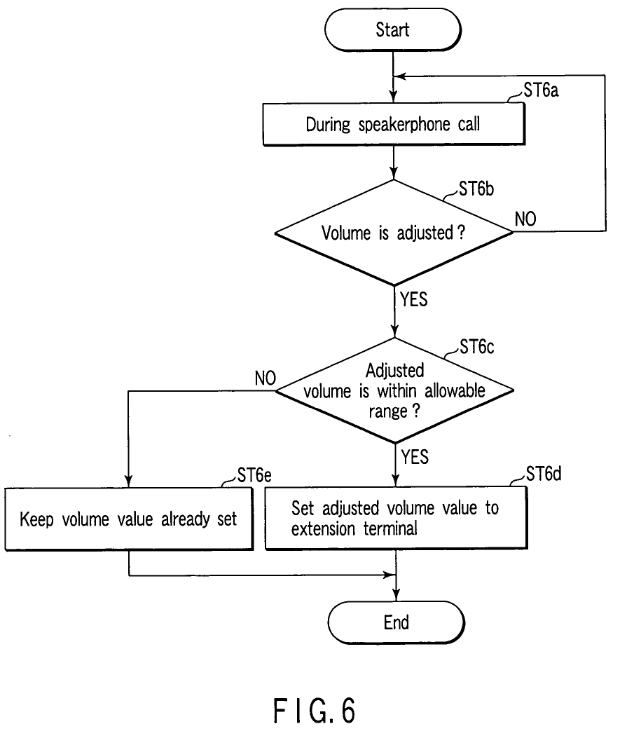

FIG. 6 is a flowchart to explain the procedure of the CPU 14B of the main unit 1B when making the speakerphone call.

For example, a speakerphone call is made between extension terminals 2-1 and 2-3. The CPU 14B monitors a speakerphone call state (step ST6a), and determines whether or not a user of the extension terminals 2-1 makes volume adjustment during the speakerphone call (step ST6b).

If the volume adjustment is made (Yes), the CPU 14B determines whether or not the adjusted volume value exceeds the corresponding maximum volume value “bb” of the range memory 152, or is less than the minimum volume value “dd” thereof (step ST6c). If the adjusted volume value is less than the maximum volume value “bb” and more than the minimum volume value “dd” (Yes), the CPU 14B sets the adjusted volume value to the extension terminal 2-1 (step ST6d).

On the other hand, if the adjusted volume value exceeds the maximum volume value “bb” and is less than the minimum volume value “dd” (No), the CPU 14B keeps the volume value already set to the extension terminal 2-1 (step ST6e).

In the foregoing step ST6b, if no volume adjustment is made (No), the CPU 14B transfers to the procedure of step ST6a.

In addition, a speakerphone call is made between the extension terminal 2-1 and the external terminal on the office line L. In also case, the CPU 14B determines whether or not the adjusted volume value exceeds the corresponding maximum volume value “aa” of the range memory 152, or is less than the minimum volume value “cc” thereof. If the adjusted volume value is less than the maximum volume value “aa” and more than the minimum volume value “cc”, the CPU 14B sets the adjusted volume value to the extension terminal 2-1.

According to the second embodiment, the maximum and minimum volume values corresponding to each call mode are stored in the range memory 152. When the user of the extension terminal 2-1 making a speakerphone call adjusts the volume, the CPU 14B makes the following determination. That is, the CPU 14B determines whether or not the adjusted volume value is less than the corresponding maximum volume value of the range memory 152, or is less than the minimum volume value thereof. If the adjusted volume value is less than the maximum volume value, and is more than the minimum volume value, the CPU 14B sets the adjusted volume value to the extension terminal 2-1 making a speakerphone call.

Therefore, it is possible to make a speakerphone call with the optimum volume value in accordance with user's favorite, and to solve the problem that a changeover from the speakerphone function to the transmission function is not made.

### Other Embodiments

The present invention is not limited to the foregoing embodiments. According to the foregoing embodiments, the volume value of the extension call is set smaller than that of the outside call. In this case, the volume value of the extension call may be set smaller than that of the outside call within a speakerphone transmission allowable range in accordance with available condition.

According to the second embodiment, the volume range memory stores both maximum and minimum volume values for each call mode. In this case, either of maximum and minimum volume values may be stored. In addition, a reference volume value is previously stored for each call mode of the volume range memory. If the difference between an adjusted volume value and the reference volume value is within a predetermined value, the adjusted volume value is set to the extension terminal.

Besides, the configuration of the main unit, kind of extension terminal and office line and the method of setting volume value may be variously modified within the scope without diverging from the subject matter of the invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A telephone exchange apparatus, which includes several extensions each adapted to connect a telephone terminal, and adapted to connect with at least one outside line, adapted to make a call other telephone terminal in an on-hook sate by the telephone terminal, comprising:
a memory which stores several different volume values for each call mode indicating a combination of connected lines;
a determination circuit configured to determine a call mode of the telephone terminal when a call is made using the telephone terminal in the on-hook state; and
a controller which controls the memory to read a volume value corresponding to the determined call mode from the memory, and sets the volume value to the calling telephone terminal.

2. The apparatus according to claim 1, wherein the controller compares an adjusted volume value with the corresponding volume value of the memory when a telephone terminal of the on-hook state makes volume adjustment, and sets the volume value adjusted based on the comparative result to the telephone terminal.

3. The apparatus according to claim 1, wherein the memory stores a maximum volume value every the call mode, and
the controller determines whether or not an adjusted volume value is more than the corresponding maximum volume value of the memory when a telephone terminal of the on-hook state makes volume adjustment, and sets the adjusted volume value to the telephone terminal only when the adjusted volume value is less than the maximum volume value.

4. The apparatus according to claim 2, wherein the memory stores a minimum volume value every the call mode, and
the controller determines whether or not an adjusted volume value is more than the corresponding minimum volume value of the memory when a telephone terminal of the on-hook state makes volume adjustment, and sets the adjusted volume value to the telephone terminal only when the adjusted volume value is more than the minimum volume value.

5. The apparatus according to claim 1, wherein the memory stores a first volume value corresponding to information showing a call between the extension and the outside line, and a second volume value corresponding to information showing at least one of a call between the extensions and a call including the extension and the outside line, and smaller than the first volume value.

6. A control method used for a telephone exchange apparatus, which includes several extensions each adapted to connect a telephone terminal, and adapted to connect with at least one outside line, adapted to make a call other telephone terminal in an on-hook sate by the telephone terminal, comprising:
storing several different volume values for each call mode showing a combination of connected lines;
determining a call mode of the telephone terminal when a call is made using the telephone terminal in the on-hook state; and
reading a volume value corresponding to the determined call mode from the memory, and setting the volume value to the calling telephone terminal.

7. The method according to claim 6, wherein the setting includes comparing an adjusted volume value with the corresponding volume value of the memory when a telephone terminal of the on-hook state makes volume adjustment, and setting the volume value adjusted based on the comparative result to the telephone terminal.

8. The method according to claim 7, wherein the storing includes storing a maximum volume value every the call mode, and
the setting includes determining whether or not an adjusted volume value is more than the corresponding maximum volume value of the memory when a telephone terminal of the on-hook state makes volume adjustment, and setting the adjusted volume value to the telephone terminal only when the adjusted volume value is less than the maximum volume value.

9. The method according to claim 7, wherein the storing includes storing a minimum volume value every the call mode, and
the setting includes determining whether or not an adjusted volume value is more than the corresponding minimum volume value of the memory when a telephone terminal of the on-hook state makes volume adjustment, and setting the adjusted volume value to the telephone terminal only when the adjusted volume value is more than the minimum volume value.

10. The method according to claim 6, wherein the storing includes storing a first volume value corresponding to information showing a call between the extension and the outside line, and a second volume value corresponding to information showing at least one of a call between the extensions and a call including the extension and the outside line, and smaller than the first volume value.
